(19) United States
(12) Patent Application Publication
(10) Pub. No.: US 2010/0090008 A1
(43) Pub. Date: Apr. 15, 2010

(54) AUTHENTICATION SEAL

(76) Inventors: Oded BASHAN, Rosh Pina (IL); Guy SHAFRAN, Hong Kong (HK)

Correspondence Address: ABELMAN, FRAYNE & SCHWAB, 666 THIRD AVENUE, 10TH FLOOR, NEW YORK, NY, 10017, US

(21) Appl. No.: 12/250,050

(22) Filed: Oct. 13, 2008

(51) Int. Cl. G06K 7/10; B31B 1/62

(52) U.S. Cl. 235/488; 156/60

(57) ABSTRACT

An authentication seal suitable for affixing to physical objects sought to be notarized, legalized or otherwise authenticated, the authentication seal including an object interface layer including an adhesive surface for fixed engagement with a surface of an object sought to be authenticated, an inlay layer, fixed to the object interface layer, the inlay layer including a substrate having embedded thereon a wireless communication antenna coupled to an electronic chip device containing authentication information which is wirelessly readable via the wireless communication antenna and an outer layer, fixed to the inlay layer and having visually sensible authentication indicia thereon.

### FIELD OF THE INVENTION

The present invention relates to authentication seals suitable for affixing to physical objects sought to be notarized, legalized or otherwise authenticated, and to methods of manufacture thereof.

### BACKGROUND OF THE INVENTION

The following patent publications are believed to represent the current state of the art:

U.S. Pat. Nos. 7,278,580; 7,271,039; 7,269,021; 7,243,840; 7,240,847 and 7,204,427.

### SUMMARY OF THE INVENTION

The present invention relates to authentication seals suitable for affixing to physical objects sought to be notarized, legalized or otherwise authenticated, and to methods of manufacture thereof.

There is thus provided in accordance with a preferred embodiment of the present invention an authentication seal suitable for affixing to physical objects sought to be notarized, legalized or otherwise authenticated, the authentication seal including an object interface layer including an adhesive surface for fixed engagement with a surface of an object sought to be authenticated, an inlay layer, fixed to the object interface layer, the inlay layer including a substrate having embedded thereon a wireless communication antenna coupled to an electronic chip device containing authentication information which is wirelessly readable via the wireless communication antenna and an outer layer, fixed to the inlay layer and having visually sensible authentication indicia thereon.

There is also provided in accordance with another preferred embodiment of the present invention a method for manufacturing an authentication seal suitable for affixing to physical objects sought to be notarized, legalized or otherwise authenticated, the method including producing a seal inlay layer by embedding onto a substrate a wireless communication antenna coupled to an electronic chip device adapted to contain authentication information which is wirelessly readable via the wireless communication antenna, adhering an object interface layer, including an adhesive surface for fixed engagement with a surface of an object sought to be authenticated, to the inlay layer and adhering an outer layer, having visually sensible authentication indicia thereon, to the inlay layer.

There is further provided in accordance with yet another preferred embodiment of the present invention a method for authenticating an object including providing an authentication seal suitable for affixing to physical objects sought to be notarized, legalized or otherwise authenticated, the authentication seal including a seal inlay layer formed by embedding onto a substrate a wireless communication antenna coupled to an electronic chip device adapted to contain authentication information which is wirelessly readable via the wireless communication antenna, an object interface layer, including an adhesive surface for fixed engagement with a surface of an object sought to be authenticated, adhered to the inlay layer and an outer layer, having visually sensible authentication indicia thereon, adhered to the inlay layer, fixing the object interface layer onto a physical object sought to be notarized, legalized or otherwise authenticated and at least one of writing to or reading from the electronic chip device the authentication information via the wireless communication antenna.

There is even further provided in accordance with still another preferred embodiment of the present invention a method for manufacturing an authentication seal suitable for affixing to physical objects sought to be notarized, legalized or otherwise authenticated, the method including producing a combined seal inlay and object interface layer by embedding onto a substrate a wireless communication antenna coupled to an electronic chip device adapted to contain authentication information which is wirelessly readable via the wireless communication antenna and providing the substrate with an adhesive surface for fixed engagement with a surface of an object sought to be authenticated and adhering an outer layer, having visually sensible authentication indicia thereon, to the combined seal inlay and object interface layer.

There is still further provided in accordance with another preferred embodiment of the present invention a method for manufacturing an authentication seal suitable for affixing to physical objects sought to be notarized, legalized or otherwise authenticated, the method including producing a combined seal inlay and outer layer by embedding onto a substrate a wireless communication antenna coupled to an electronic chip device adapted to contain authentication information which is wirelessly readable via the wireless communication antenna and providing, on an outer surface of the substrate, visually sensible authentication indicia and adhering an object interface layer, including an adhesive surface for fixed engagement with a surface of an object sought to be authenticated, to the combined seal inlay and outer layer.

There is also provided in accordance with yet another preferred embodiment of the present invention a method for authenticating an object including providing an authentication seal suitable for affixing to physical objects sought to be notarized, legalized or otherwise authenticated, the authentication seat including a combined seal inlay and object interface layer formed by embedding onto a substrate a wireless communication antenna coupled to an electronic chip device adapted to contain authentication information which is wirelessly readable via the wireless communication antenna and providing the substrate with an adhesive surface for fixed engagement with a surface of an object sought to be authenticated and an outer layer, having visually sensible authentication indicia thereon, adhered to the combined seal inlay and object interface layer fixing the combined seal inlay and object interface layer onto a physical object sought to be notarized, legalized or otherwise authenticated and at least one of writing to or reading from the electronic chip device the authentication information via the wireless communication antenna.

There is yet further provided in accordance with still another preferred embodiment of the present invention a method for authenticating an object including providing an authentication seal suitable for affixing to physical objects sought to be notarized, legalized or otherwise authenticated, the authentication seal including a combined seal inlay and outer layer formed by embedding onto a substrate a wireless communication antenna coupled to an electronic chip device adapted to contain authentication information which is wirelessly readable via the wireless communication antenna and providing, on an outer surface of the substrate, visually sensible authentication indicia and an object interface layer, including an adhesive surface for fixed engagement with a surface of an object sought to be authenticated, adhered to the inlay layer, fixing the object interface layer onto a physical object sought to be notarized, legalized or otherwise authenticated and at least one of writing to or reading from the electronic chip device the authentication information via the wireless communication antenna.

Preferably, the electronic chip device is adapted to contain authentication information which is wirelessly writable therein via the wireless communication antenna.

In accordance with a preferred embodiment of the present invention the outer layer is formed with forgery resistant indicia.

Preferably, the electronic chip device is a smart card chip device.

### BRIEF DESCRIPTION OF THE DRAWINGS

The present invention will be understood and appreciated more fully from the following detailed description, taken in conjunction with the drawings in which:

FIG. 1 is a simplified, exploded view illustration of an authentication seal constructed and operative in accordance with a preferred embodiment of the present invention;

FIG. 2 is a simplified, assembled view of the authentication seal of FIG. 1;

FIG. 3 is a simplified sectional illustration of the authentication seal of FIGS. 1 and 2, taken along the lines III-III in FIG. 2; and

FIG. 4 is a simplified pictorial illustration of the authentication seal of FIGS. 1-3 affixed to a document.

### DETAILED DESCRIPTION OF A PREFERRED EMBODIMENT

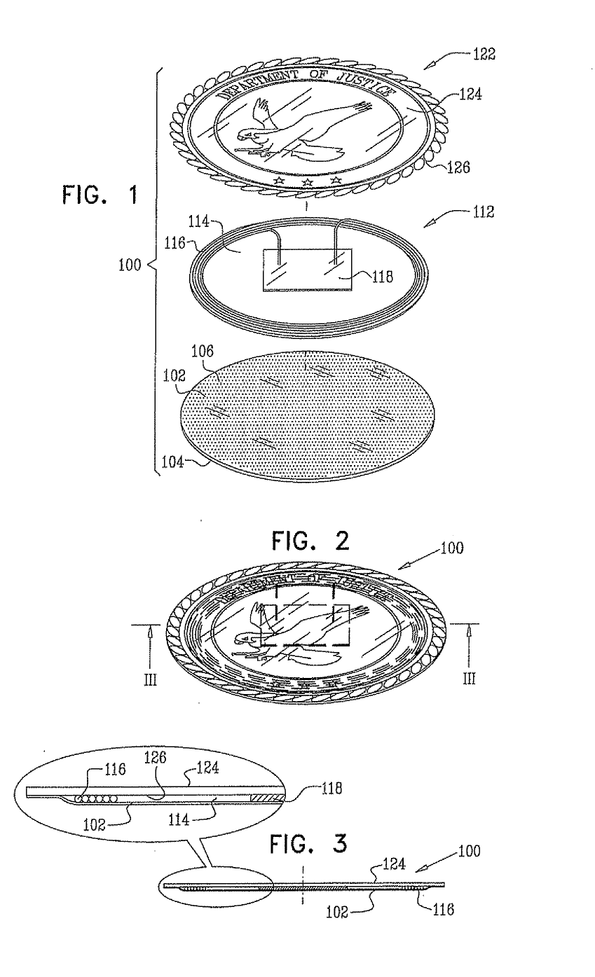

Reference is now made to FIGS. 1-3, which illustrate an authentication seal 100 suitable for affixing to physical objects, sought to be notarized, legalized or otherwise authenticated, constructed and operative in accordance with a preferred embodiment of the present invention. As seen with particular clarity in FIG. 1, the authentication seal 100 includes an object interface layer 102, preferably a double sided adhesive layer, including an underside adhesive surface 104 for secure engagement with a surface of an object, such as a document, sought to be authenticated. Object interface layer 102 also preferably includes a topside adhesive surface 106.

An inlay layer 112 is preferably fixedly adhered to topside adhesive surface 106 of object interface layer 102. The inlay layer 112 preferably includes a substrate 114 having embedded thereon a wireless communication antenna 116 coupled to an electronic chip device 118, such as a smart card chip, containing authentication information, which is wirelessly readable by an external reader (not shown) via the wireless communication antenna 116. Preferably, the authentication information is wirelessly writable to the electronic chip device 118 via the wireless communication antenna 116.

The inlay layer 112 is preferably produced by using ultrasonic wire embedding techniques which are known in the art. Such techniques are described, inter alia, in U.S. Pat. Nos. 6,628,240; 6,626,364 and 6,604,686, the disclosures of which are hereby incorporated by reference. Alternatively, inlay layer 112 may be produced by other suitable methods, such as heat and/or pressure based wire embedding techniques, or printing wireless communication antenna 116 of inlay layer 112 on substrate 114 using a conductive fluid material, such as silver.

An outer layer 122, having visually sensible, preferably forgery resistant, authentication indicia on a topside surface 124 thereof, is preferably formed with an underside adhesive surface 126 for secure engagement to inlay layer 112.

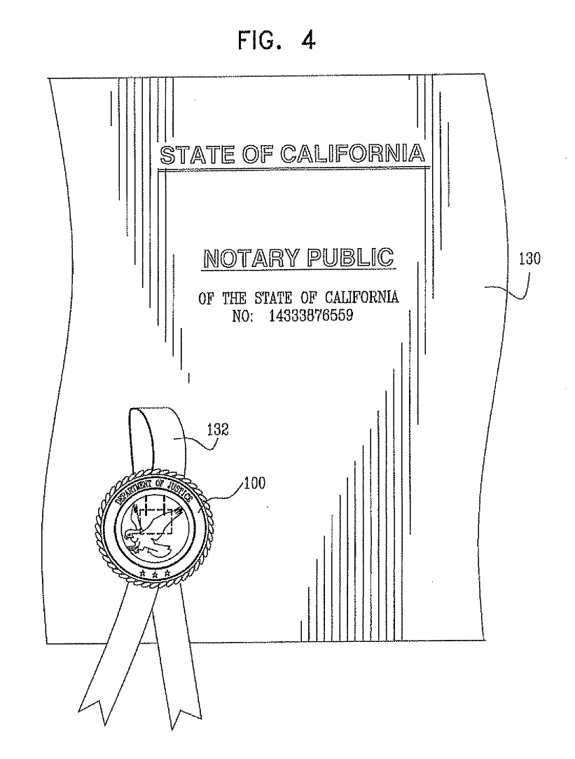

FIG. 4 is a simplified pictorial illustration of the authentication seal 100 of FIGS. 1-3 affixed to a document 130. It is noted that a ribbon 132 or other suitable object may be securely retained between authentication seal 100 and document 130 or another object to which authentication seal 100 is adhered.

It is appreciated that, as seen in FIG. 2, authentication seal 100 may be initially formed with object interface layer 102, inlay layer 112 and outer layer 122. Alternatively, the authentication seal 100 of FIGS. 1-3 may be initially formed with object interface layer 102 and inlay layer 112. In this alternative embodiment, outer layer 122 is preferably adhered to inlay layer 112 of authentication seal 100 at the time authentication seal 100 is affixed to a physical object, sought to be notarized, legalized or otherwise authenticated.

It is also appreciated that one or more of object interface layer 102, inlay layer 112 and outer layer 122 may be combined into a single layer.

It will be appreciated by persons skilled in the art that the present invention is not limited to what has been particularly shown and described hereinabove. Rather the scope of the invention includes both combinations and subcombinations of the various features described hereinabove as well as modifications and variations thereof which would occur to persons skilled in the art upon reading the foregoing description and which are not in the prior art.

1. An authentication seat suitable for affixing to physical objects sought to be notarized, legalized or otherwise authenticated, the authentication seal comprising:
an object interface layer including an adhesive surface for fixed engagement with a surface of an object sought to be authenticated;
an inlay layer, fixed to said object interface layer, said inlay layer comprising a substrate having embedded thereon a wireless communication antenna coupled to an electronic chip device containing authentication information which is wirelessly readable via said wireless communication antenna; and
an outer layer, fixed to said inlay layer and having visually sensible authentication indicia thereon.

2. An authentication seal according to claim 1 and wherein said electronic chip device contains authentication information which is wirelessly writable therein via said wireless communication antenna.

3. An authentication seal according to claim 1 and wherein said outer layer is formed with forgery resistant indicia.

4. An authentication seal according to claim 1 wherein said electronic chip device is a smart card chip device.

5. An authentication seal according to claim 1 wherein said object interface layer and said inlay layer are formed as a single layer.

6. An authentication seal according to claim 1 wherein said inlay layer and said outer layer are formed as a single layer.

7. A method for manufacturing an authentication seal suitable for affixing to physical objects sought to be notarized, legalized or otherwise authenticated, the method comprising:
producing a seal inlay layer by embedding onto a substrate a wireless communication antenna coupled to an electronic chip device adapted to contain authentication information which is wirelessly readable via said wireless communication antenna;
adhering an object interface layer, including an adhesive surface for fixed engagement with a surface of an object sought to be authenticated, to said inlay layer;
and adhering an outer layer, having visually sensible authentication indicia thereon, to said inlay layer.

8. A method for manufacturing an authentication seal according to claim 7 and wherein said electronic chip device is adapted to contain authentication information which is wirelessly writable therein via said wireless communication antenna.

9. A method for manufacturing an authentication seal according to claim 7 or claim 8 and wherein said outer layer is formed with forgery resistant indicia.

10. A method for manufacturing an authentication seal according to claims 7 and wherein said electronic chip device is a smart card chip device.

11. A method for manufacturing an authentication seal suitable for affixing to physical objects sought to be notarized, legalized or otherwise authenticated, the method comprising:
producing a combined seal inlay and object interface layer by embedding onto a substrate a wireless communication antenna coupled to an electronic chip device adapted to contain authentication information which is wirelessly readable via said wireless communication antenna and providing said substrate with an adhesive surface for fixed engagement with a surface of an object sought to be authenticated: and
adhering an outer layer, having visually sensible authentication indicia thereon, to said combined seal inlay and object interface layer.

12. A method for manufacturing an authentication seal suitable for affixing to physical objects sought to be notarized, legalized or otherwise authenticated, the method comprising:
producing a combined seal inlay and outer layer by embedding onto a substrate a wireless communication antenna coupled to an electronic chip device adapted to contain authentication information which is wirelessly readable via said wireless communication antenna and providing, on an outer surface of said substrate, visually sensible authentication indicia; and
adhering an object interface layer, including an adhesive surface for fixed engagement with a surface of an object sought to be authenticated, to said combined seal inlay and outer layer.

13. A method for authenticating an object comprising:
providing an authentication seal suitable for affixing to physical objects sought to be notarized, legalized or otherwise authenticated,
fixing said authentication seal onto a physical object sought to be notarized, legalized or otherwise authenticated; and
writing to or reading from said electronic chip device said authentication information via said wireless communication antenna.
